(19) United States
(12) Patent Application Publication
(10) Pub. No.: US 2005/0242706 A1
(43) Pub. Date: Nov. 3, 2005

(54) Cathode substrate for electron emission device, electron emission device, and method of manufacturing the same

(76) Inventors: You-Jong Kim, Suwon-si (KR); Chun-Gyoo Lee, Suwon-si (KR); Sang-Jo Lee, Suwon-si (KR)

Correspondence Address: Robert E. Bushnell;Suite 300, 1522 K Street, N.W., Washington, DC, 20005-1202, US

(21) Appl. No.: 11/117,564

(22) Filed: Apr. 29, 2005

(30) Foreign Application Priority Data
Apr. 29, 2004 (KR) 10-2004-0029987

(51) Int. Cl. H01J 1/02

(52) U.S. Cl. 313/497

(57) ABSTRACT

A cathode substrate for an electron emission device includes a substrate, electron emission regions formed on the substrate, and one or more driving electrodes controlling the electrons emitted from the electron emission regions. A first insulating layer contacts the driving electrodes. A focusing electrode is provided in the cathode substrate to focus the electrons emitted from the electron emission regions. A second insulating layer is located between the driving electrodes and the focusing electrode. The materials used in the first and the second insulating layers have different etch rates.

### CLAIM OF PRIORITY

This application makes reference to, incorporates the same herein, and claims all benefits accruing under 35 U.S.C. §119 from an application for CATHODE SUBSTRATE FOR ELECTRON EMISSION DEVICE, ELECTRON EMISSION DEVICE, AND METHOD OF MANUFACTURING THE SAME earlier filed in the Korean Intellectual Property Office on 29 Apr. 2004 and there duly assigned Serial No. 10-2004-0029987.

### BACKGROUND OF THE INVENTION

1. Field of the Invention

The present invention relates to an electron emission device, and in particular, to an electron emission device and a method of manufacturing the same, the electron emission device having a cathode substrate, and two insulating layers formed in the cathode substrate with different materials to enhance production efficiency.

2. Description of the Related Art

Generally, electron emission devices are classified into a first type where a hot cathode is used as an electron emission source, and a second type where a cold cathode is used as the electron emission source. The second typed electron emission devices can further be classified into a field emitter array (FEA) type, a surface conduction emission (SCE) type, a metal-insulator-metal (MIM) type, or a metal-insulator-semiconductor (MIS) type.

The MIM type and the MIS type electron emission devices have a metal/insulator/metal (MIM) electron emission structure and a metal/insulator/semiconductor (MIS) electron emission structure, respectively. When voltages are applied to the metallic layers or to the metallic and the semiconductor layers, electrons migrate and accelerate from the metallic layer or the semiconductor layer having a high electric potential to the metallic layer having a low electric potential, thus achieving the electron emission.

The SCE type electron emission device includes first and second electrodes formed on a substrate while facing each other, and a conductive thin film located between the first and the second electrodes. Micro-cracks are made in the conductive thin film to form electron emission regions. When voltages are applied to the electrodes while making an electric current flow to the surface of the conductive thin film, electrons are emitted from the electron emission regions.

The FEA type electron emission device is based on the principle that when a material having a low work function or a high aspect ratio is used as an electron emission source, electrons are easily emitted from the material due to the electric field in a vacuum atmosphere. A front sharp-pointed tip structure based on molybdenum Mo or silicon Si, or a carbonaceous material, such as carbon nanotube, graphite and diamond-like carbon, has been developed to be used as the electron emission source.

A cold cathode-based electron emission device has first and second substrates forming a vacuum vessel. Electron emission regions and driving electrodes for controlling the electron emission from the electron emission regions are formed on the first substrate. Phosphor layers and an anode electrode for effectively accelerating the electrons emitted from the side of the first substrate toward the phosphor layers are formed on the second substrate, thus emitting light and displaying the desired images.

With the above-structured electron emission device, when the electrons emitted from the electron emission regions proceed toward the second substrate, they are diffused at a predetermined inclination angle, thus deteriorating the screen color purity. Furthermore, when a high voltage is applied to the anode electrode provided in the second substrate, the high voltage from the anode interferes with and affects the electron emission regions, thus making an unintended electron emission.

Accordingly, in order to solve such a problem, it has been proposed that a grid substrate should be located between the first and the second substrates. The grid substrate is formed with a thin metallic plate having a plurality of beam passage holes, and placed between the first and the second substrates at a predetermined distance. When the electron emission device is driven, a plus (+) direct current voltage of several tens to hundreds volts is applied to the grid substrate. The grid substrate intercepts the electrons diffused from the electron emission regions, and prevents the unintended electrons from being emitted due to the high voltage of the anode electrode.

However, in case the electron emission device has a grid substrate, it is very difficult to handle and arrange the grid substrate together with the first and the second substrates during the assembling thereof, and this results in reduced production yield and increased production cost.

### SUMMARY OF THE INVENTION

It is therefore an object of the present invention to provide an improved design for an electron emission device.

It is further an object of the present invention to provide a method of manufacturing the improved electron emission device.

It is yet another object of the present invention to provide a design for an cold cathode electron emission device where the high voltages applied to the anode to not interfere with the ability of the electron emitter to emit electrons.

It is still an object of the present invention to provide a method of making the improved electron emission device where the number of process steps is reduced and the overall process is simplified.

It is also an object to provide a cathode substrate for an electron emission device that results in improved screen color purity.

It is still an object of the present invention to provide a method of making the cathode substrate that is highly efficient.

These and other objects maybe achieved by an electron emission device having a cathode substrate that includes an electron emission device includes a substrate, electron emission regions formed on the substrate, and one or more driving electrodes for controlling the electrons emitted from the electron emission regions. A first insulating layer contacts the driving electrodes. The cathode substrate is provided with a focusing electrode for focusing the electrons emitted from the electron emission regions. A second insulating layer is located between the driving electrodes and the focusing electrode. The first and the second insulating layers are formed with different kinds of materials.

The first and the second insulating layers are formed of different material that results in different etch rates. In at least one embodiment, the etch rate of the material used for the first insulating layer is ⅓ or less than the etch rate the material used in the second insulating layer. Alternatively, in another embodiment, the etch rate of the material used in the first insulating layer can be three times or more of the etch rate of the material used in the second insulating layer. The material used in the driving electrodes and the material used in the second insulating layer have different etch rates. The etch rate of the material used in the driving electrodes is 1/10 or less of the etch rate of the material used in the second insulating layer.

In another exemplary embodiment of the present invention, the electron emission device includes first and second substrates facing each other, and first and second electrodes insulated from each other on the first substrate with a first insulating layer there between. Electron emission regions are connected to either the first electrodes or the second electrodes. A focusing electrode is formed over the first and second electrodes while exposing the electron emission regions. A second insulating layer is located between the focusing electrode and either the second electrodes or the first electrodes. The first and the second insulating layers are formed with different kinds of materials. Phosphor layers are formed on the second substrate. At least one anode electrode is formed on a surface of the phosphor layers.

The material used in the first insulating layer has a different etch rate than the material used in the second insulating layer. The material used for the second insulating layer has a different etch rate than the material used in either the the first electrodes or the second electrodes.

In a method of manufacturing the electron emission device, first and second driving electrodes are formed on a first substrate such that a first insulating layer is located between the first substrate and the driving electrodes. A second insulating layer is formed on the driving electrodes such that the material used in the second insulating layer has a different etch rate than the material used in the first insulating layer. A focusing electrode is formed on the second insulating layer. The second insulating layer is partially etched using an etching solution or an etching gas to partially expose the second driving electrodes.

Thereafter, electron emission regions can be formed on the exposed portions of the second driving electrodes. Alternatively, the first insulating layer can be partially etched to partially expose is the first driving electrodes, followed by forming electron emission regions on the exposed portions of the first driving electrodes. In the former case, when the first and the second insulating layers are formed, the first insulating layer can be formed using a material having an etch rate being ⅓ or less than the etch rate of the material used in the second insulating layer. In the latter case, when the first and the second insulating layers are formed, the first insulating layer can be formed with a material having an etch rate being three times or more of the etch rate of the material that makes up the second insulating layer. When the second and the first insulating layers are partially etched, the second and the first insulating layers can be processed only through a single etching process using the same etching solution or etching gas.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial exploded perspective view of an electron emission device according to a first embodiment of the present invention;

FIG. 2 is a partial sectional view of the electron emission device according to the first embodiment of the present invention;

FIGS. 3A to 3E schematically illustrate a method of manufacturing the electron emission device illustrated in FIGS. 1 and 2 according to the present invention;

FIG. 4A is a partial sectional view of the electron emission device according to the first embodiment of the present invention, illustrating a variant of the gate electrode;

FIG. 4B is a plan view of the gate electrode illustrated in FIG. 4A;

FIG. 5 is a partial sectional view of an electron emission device according to a second embodiment of the present invention;

FIG. 6 is a partial plan view of the first substrate illustrated in FIG. 5;

FIGS. 7A to 7E schematically illustrate a method of manufacturing the electron emission device illustrated in FIG. 5 according to the present invention;

FIG. 8 is a partial sectional view of the electron emission device according to the second embodiment of the present invention, illustrating a variant of the cathode electrode;

FIG. 9 is a partial sectional view of an electron emission device according to a third embodiment of the present invention;

FIGS. 10A to 10D schematically illustrate a method of manufacturing the electron emission device illustrated in FIG. 9 according to the present invention; and

FIG. 11 is a partial sectional view of the electron emission device according to the third embodiment of the present invention, illustrating a variant of the cathode electrode.

### DETAILED DESCRIPTION OF THE INVENTION

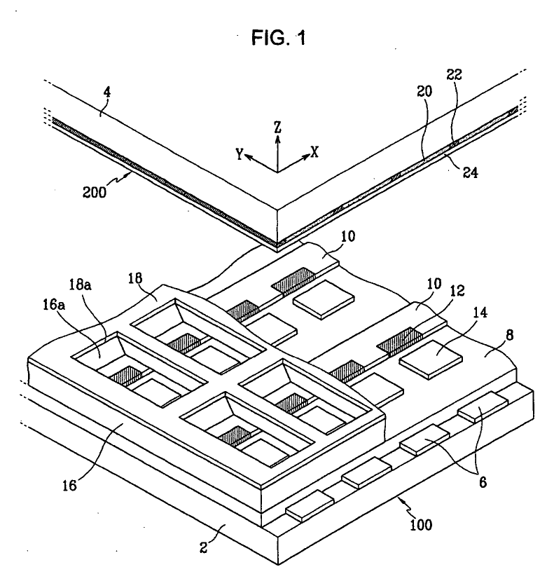

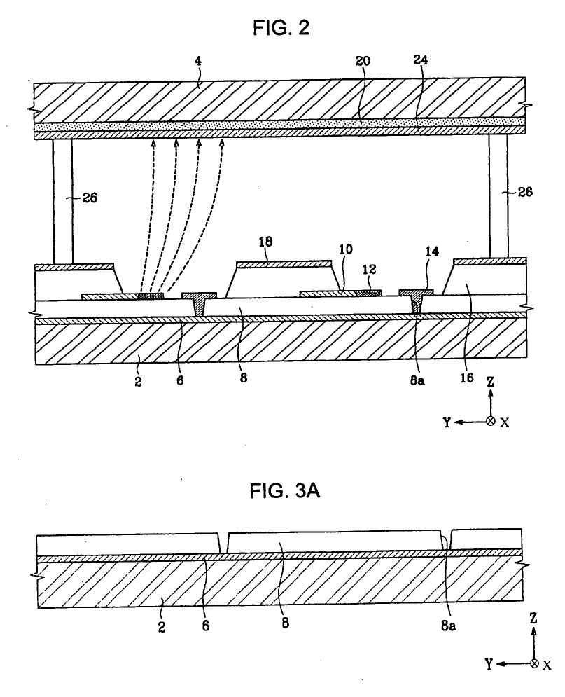

Turning now to the figures, FIGS. 1 and 2 illustrate an electron emission device according to a first embodiment of the present invention. As illustrated in FIGS. 1 and 2, the electron emission device includes cathode and anode substrates 100 and 200 arranged parallel to each other and spaced apart from each other by a predetermined distance, and assembled to make a vacuum vessel therebetween. The cathode substrate 100 refers to the substrate where an electron emission structure is provided to emit electrons, and an anode substrate 200 refers to the substrate where visible rays are emitted due to the electrons, and the desired images are displayed.

Specifically, the cathode and the anode substrates 100 and 200 have the following structural components. First, gate electrodes 6 being the first electrodes are in a stripe pattern on the first substrate 2 in a direction on the first substrate 2 (in the Y axis direction of the drawing), and a first insulating layer 8 is formed on the entire surface of the first substrate 2 covering the gate electrodes 6. A plurality of cathode electrodes 10 being the second electrodes are formed on the first insulating layer 8 while extending perpendicular to the gate electrodes 6.

Electron emission regions 12 are formed in the cathode electrodes 10 while partially contacting the cathode electrodes 10 such that they are electrically connected to the cathode electrodes 10. In this embodiment, when the crossed regions of the gate electrodes 6 and the cathode electrodes 10 are defined as the pixel regions, the electron emission regions 12 are formed in the respective pixel regions defined on the first substrate 2. Furthermore, as illustrated in the FIGS. 1 and 2, the electron emission regions 12 are placed in the one-sided peripheries (at one edge) of the cathode electrodes 10 per the respective pixel regions, and surrounded by the cathode electrodes 10 in the one or more lateral sides thereof.

The electron emission regions 12 are made of a material that emits electrons when in an electric field, such as carbon nanotube, graphite, diamond, diamond-like carbon, C₆₀ (fulleren), silicon nanowire, or a combination thereof. The electron emission regions 12 can be formed through screen printing, direct growth, chemical vapor deposition (CVD), or sputtering.

Counter electrodes 14 are formed on the first substrate 2 over the first insulating layer to attract the electric field of the gate electrodes 6. The counter electrodes 14 are spaced apart from the electron emission regions 12 and between the cathode electrodes 10. Counter electrodes 14 contact the gate electrodes 6 through via holes 8a formed through the first insulating layer 8 such that the counter electrodes 12 are electrically connected to the gate electrode 6.

When predetermined driving voltages are applied to the cathode and the gate electrodes 10 and 6 while forming electric fields around the electron emission regions 12, the counter electrodes 14 also additionally sculpt the electric fields for emitting electrons from the electron emission regions 12. As with the electron emission regions 12, the counter electrodes 14 can be provided corresponding to the respective pixel regions defined on the first substrate 2.

A second insulating layer 16 and a focusing electrode 18 are formed on the cathode electrode 10 and the first insulating layer 8 with opening portions 16a and 18a exposing the electron emission regions 12. As illustrated in FIGS. 1 and 2, the focusing electrode 18 is formed on the entire surface of the second insulating layer 16, or can be patterned into stripes. The formation of the focusing electrode 18 on the second insulating layer 16 is achieved by depositing or sputtering a metallic layer. Alternatively, a metallic plate with opening portions 18a can be attached onto the second insulating layer 16.

When the electron emission device is driven, the focusing electrode 18 focuses the electrons emitted from the electron emission regions 12, and prevents the high voltage applied to the side of the second substrate 4 from interfering with the electric field formed about the electron emission regions 12. The second insulating layer 16 is located between the cathode electrodes 10 and the focusing electrode 18 and serves to prevent a short between them. As the thickness of the second insulating layer 16 becomes larger, the electron beam focusing effect of the focusing electrode 18 can be increased. The thickness of the second insulating layer 18 is preferably established to be 10 μm or more.

The opening portions 16a and 18a of the second insulating layer 16 and the focusing electrode 18 can be provided corresponding to the respective pixel regions defined on the first substrate 2 to partially or totally expose the counter electrodes 14 together with the electron emission regions 12. As illustrated in FIG. 2, the partial or total exposure of the counter electrodes 14 is made to allow the electrons to pass through the opening portions 16a and 18a of the second insulating layer 16 and the focusing electrode 18 and toward the second substrate 4. This is because the electrons are intensively emitted from the one-sided peripheries (edge portions) of the electron emission regions 12 directed toward the counter electrodes 14.

As described above, the electron emission regions 12, the cathode and the gate electrodes 10 and 6 being the driving electrodes for controlling the emission of electrons from the electron emission regions 12, the focusing electrodes 18 for focusing the electron beams, and the first and the second insulating layers 8 and 16 for insulating the electrodes from each other are provided on the first substrate 2. The first and the second insulating layers 8 and 16 are formed with different kinds of materials, specifically with materials having different etch rates with respect to an etching solution or an etching gas.

The difference in etch rate is necessary to prevent the first insulating layer 8 from being etched and distorted when the second insulating layer 16 is partially etched to form opening portions 16a. The etch rate of the material that is used in the first insulating layer 8 is preferably established to be ⅓ or less of the etch rate of the material used for the second insulating layer 16 when an etching solution or an etching gas is used.

The second insulating layer 16 and the cathode electrode 10 are also formed of materials having different etch rates with respect to an etching solution or an etching gas. This is also to prevent the cathode electrode 10 from being etched and distorted when the second insulating layer 16 is partially etched to form opening portions 16a. The etch rate of the material used in the cathode electrode 10 is 1/10 or less that of the etch rate of the material used in the second insulating layer 16. For example, when the second insulating layer 16 is patterned using an etching solution containing hydrogen fluoride HF to form opening portions 16a, the cathode electrode 10 can be formed with a metallic material satisfying the above-identified etch rate condition, such as aluminum Al, chromium Cr, and molybdenum Mo.

As with the cathode electrodes 10, the counter electrodes 14 are also structured such that they are partially or totally exposed through the opening portions 16a in the second insulating layer 16. Therefore, the counter electrodes 14 are made of a material that satisfies the same etch rate condition as the material used in the cathode electrodes 10 when an etching solution or an etching gas is used. By selecting the materials used for the constituent components as such, the cathode electrodes 10 and the counter electrodes 14 are less apt to be damaged or distorted during the etching of the second insulating layer 16. The counter electrodes 14 are preferably formed with the same material as that of the cathode electrodes 10.

Phosphor layers 20 and black layers 22 are formed on the surface of the second substrate 4 facing the first substrate 2, and an anode electrode 24 is formed on the phosphor layers 20 and the black layers 22 using a metallic layer based on aluminum. The anode electrode 24 receives the voltage required for accelerating the electron beams, and reflects the visible rays radiated toward the first substrate 2 from the phosphor layers 20 to the side of the second substrate 4, thus enhancing the screen luminance. Instead, the anode electrode can be formed with a transparent conductive layer based on indium tin oxide (ITO), instead of a metallic layer. In this case, the anode electrode is formed on the surface of the phosphor layers 20 and the black layers 22 and faces the second substrate 4, and is patterned with a plurality of portions.

The above-structured cathode and anode substrates 100 and 200 are sealed to each other and spaced apart from each other by a distance using a frit-like sealing material such that the cathode electrodes 10 face the phosphor layers 20, and the inner space between the substrates 100 and 200 is exhausted to a vacuum state, thus constructing an electron emission device. A plurality of spacers 26 are arranged in the non-light emission area between the cathode and the anode substrates 100 and 200 to maintain a constant distance between the substrates 2 and 4.

The above-structured electron emission device is driven by applying predetermined voltages to the gate electrodes 6, the cathode electrodes 10, the focusing electrode 18 and the anode electrode 24. For instance, a minus (−) scan voltage of several to several tens volts is applied to the cathode electrodes 10, a plus (+) data voltage of several to several tens volts to the gate electrodes 6, a minus (−) direct current voltage of several tens to several hundreds volts to the focusing electrode 18, and a plus (+) direct current voltage of several hundreds to several thousands volts to the anode electrode 24.

An electric field is formed around the electron emission regions 12 in the pixels where the voltage difference between the gate and the cathode electrodes 6 and 10 exceeds the threshold value, and electrons are emitted from these electron emission regions 12. The emitted electrons are focused by the focusing voltage while passing the focusing electrode 18, and attracted by the high voltage applied to the anode electrode 24, thus colliding with the phosphor layers 20 in the relevant pixels while emitting visible light. During this process, the effects of the anode electrode 24 on the electron emission regions 12 is prevented because of the focusing electrode 18 and the voltage applied to the focusing electrode 18.

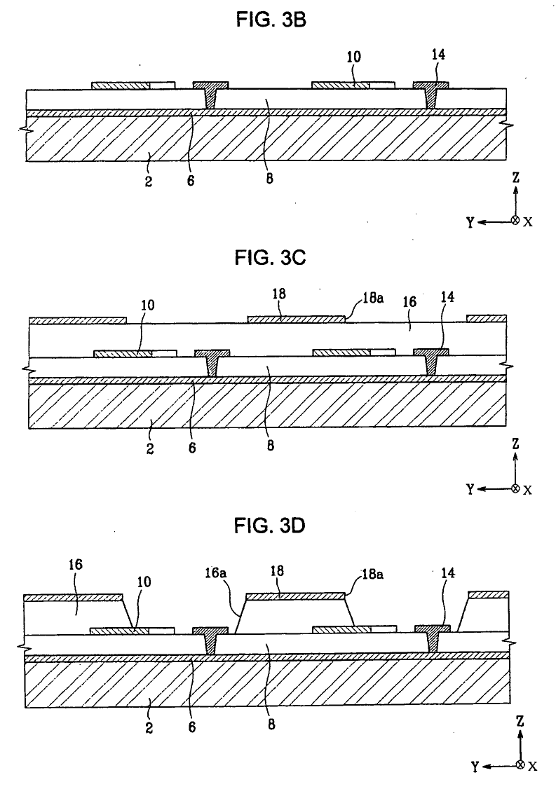

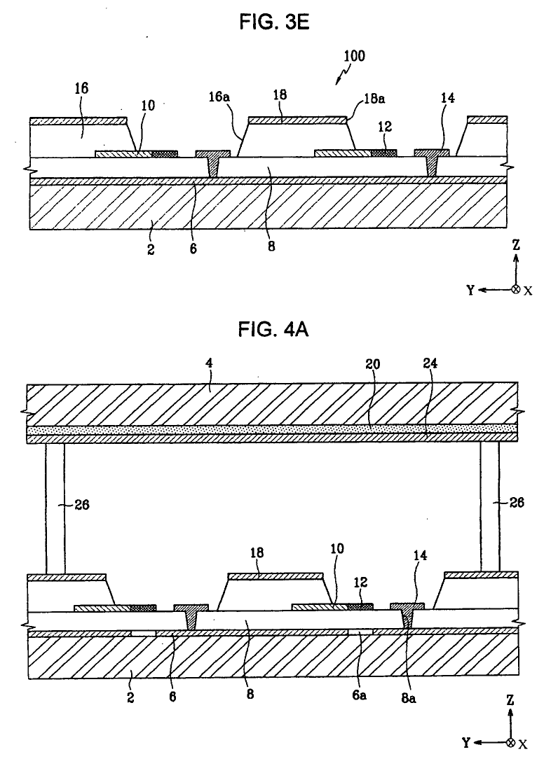

A method of manufacturing the electron emission device illustrated in FIGS. 1 and 2 according to the present invention will be now explained with reference to FIGS. 3A to 3E. First, as illustrated in FIG. 3A, gate electrodes 6 are formed on the first substrate 2 in a strip pattern extending in a first direction on the first substrate 2. A first insulating layer 8 is formed on the entire inner surface of the first substrate 2 covering the gate electrodes 6. The first insulating layer 8 can be formed to a thickness of 5-20 μm by screen printing several times.

In order to form the counter electrodes 14 on the first insulating layer 8, a photoresist layer (not illustrated) is applied on the first insulating layer 8. The photoresist is patterned and then the first insulating layer is etched to thus pattern the first insulating layer 8. After the etch of the first insulating layer 8, the patterned photoresist is removed from the first insulating layer 8.

Thereafter, as illustrated in FIG. 3B, a conductive layer is formed on the first insulating layer 8, and patterned to form cathode electrodes 10 and counter electrodes 14. In consideration of the process of etching and firing the second insulating layer 16 to be conducted later, the cathode and the counter electrodes 10 and 14 are preferably formed with a material having an etch rate being 1/10 or less of the etch rate of the material used in the second insulating layer 16. The cathode electrode 10 and the counter electrodes 14 may be formed to have a little thermal oxidation. The cathode and the counter electrodes 10 and 14 are preferably made of aluminum Al, chromium Cr or molybdenum Mo.

As illustrated in FIG. 3C, a second insulating layer 16 is formed on the cathode electrode 10 and on the counter electrode 14 on top of the first insulating layer 8. The second insulating layer 16 is formed with an insulating material having an etch rate largely differentiated from that the material used in the first insulating layer 8. Preferably, the etch rate of the material used in the second insulating layer 16 is at least three times the etch rate of the material used in the first insulating layer 8.

As the thickness of the second insulating layer 16 becomes larger, the electron beam focusing effect of the focusing electrode 18 to be formed later can be heightened. Therefore, it is preferable that the second insulating layer 16 is formed with a thickness of 10 μm or more by performing screen printing and high temperature firing over and over several times.

A conductive layer is formed on the second insulating layer 16, and patterned to form a focusing electrode 18 with opening portions 18a. Alternatively, a metallic plate with opening portions 18a can instead be attached to the second insulating layer 16 to form the focusing electrode 18. As illustrated in FIG. 3D, the second insulating layer 16 is partially etched using an etching solution or gas to form opening portions 16a. The patterned focusing electrode 18 atop of the second insulating layer 16 can be used as an etch mask for the patterning of the second insulating layer 16, thus eliminating photolithography steps. An etching solution containing hydrogen fluoride HF can be used to form the opening portions 16a. Since the etch rate of the material used in the first insulating layer 8 is no more than ⅓ the etch rate of the material used in the second insulating layer 16, the first insulating layer 8 is less apt to be damaged and/or altered during the etching of the second insulating layer 16.

Likewise, since the etch rate of the material used in the cathode and the counter electrodes 10 and 14 is no more than 1/10th the etch rate of the material used in the second insulating layer 16, the amount of alteration and/or damage to the cathode and the counter electrodes 10 and 14 can be minimized during the etching of the second insulating layer 16.

Turning now to FIG. 3E, electron emission regions 12 are now formed at a periphery at one side of the cathode electrodes 10 using an electron emission material such as carbon nanotube, graphite, diamond, diamond-like carbon, C₆₀, silicon nanowire or a combination thereof. With the formation of the electron emission regions 12, an organic material, such as a vehicle and a binder, are added to the electron emission material to form a paste with a viscosity suitable for screen printing. A photosensitive material can also be added to the paste, and the photosensitive paste is screen-printed onto the entire surface of the first substrate 2, followed by placing a photo mask (not illustrated) over the photosensitive layer. The photosensitive layer is partially exposed to light through the photo mask while being hardened, and developed to form the patterned electron emission regions 12.

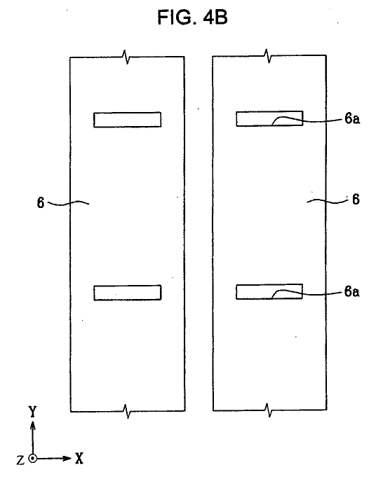

When the photosensitive material is sensitive to ultraviolet rays and ultraviolet rays are used in the above front exposure process, they do not reach the bottom surface of the electron emission regions 12, thus weakening the adhesive strength of the electron emission regions 12 and deteriorating the pattern precision thereof. Accordingly, a backside exposure technique can instead be used to pattern the photosensitive layer used to make the electron emission regions 12. As illustrated in FIGS. 4A and 4B, backside exposure opening portions 6a are formed in the gate electrodes 6, and ultraviolet rays illuminate a bottom side of cathode substrate 2 and pass through opening portions 6a to form the electron emission regions 12 with excellent adhesive strength and pattern precision.

The cathode substrate 2 is assembled with a second substrate 4 having phosphor layers 20, black layers 22 and anode electrode 24 thereon, and the inner space between the substrates 2 and 4 is exhausted to thus construct an electron emission device. Detailed explanation of the process of forming the phosphor layers 20, the black layers 22 and the anode layer 24 on the second substrate 4 and the process of assembling the substrates 2 and 4 with each other will be omitted.

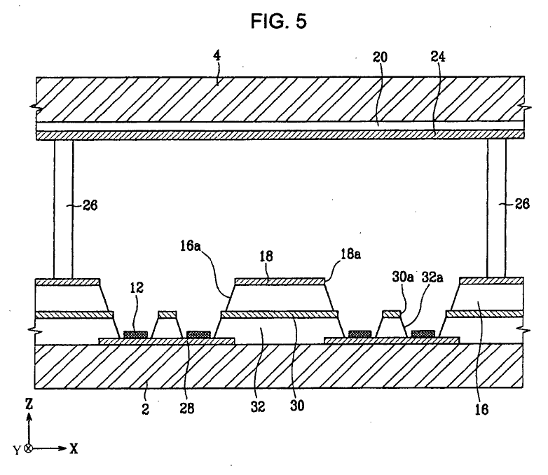

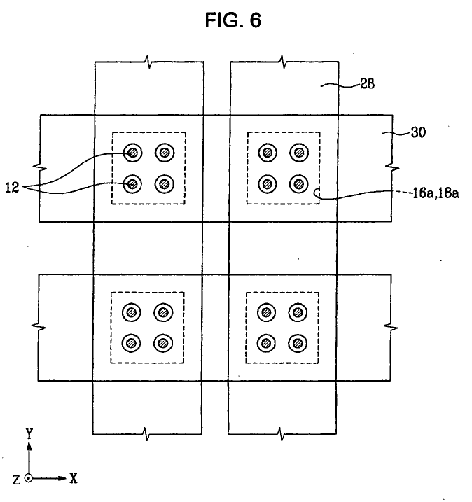

Turning to FIGS. 5 and 6, FIGS. 5 and 6 illustrate an electron emission device according to a second embodiment of the present invention. As illustrated in FIGS. 5 and 6, cathode electrodes 28 are the first electrodes to be formed on the first substrate 2, and gate electrodes 30 are the second electrodes are formed on first substrate and are formed on top of the first insulating layer 32. At least one opening portion 30a and 32a is formed in the gate electrode 30 as well as in the first insulating layer 32 per the respective pixel regions defined on the first substrate 2. Electron emission regions 12 are formed on the cathode electrodes 28 by exposure through the first opening portions 30a and 32a. Other structural components of the electron emission device according to the second embodiment are the same as those related to the first embodiment.

In this second embodiment, the first and the second insulating layers 32 and 16 are made of materials having the same etch rate relationships as those related to the first embodiment, and are formed with the same materials as those related to the first embodiment. Accordingly, when the second insulating layer 16 is partially etched to form second opening portions 16a, the damage to the first insulating layer 32 during this etching can be minimized. Furthermore, in order to minimize damage to the gate electrodes 30 when the second insulating layer 16 is partially etched to form the second opening portions 16a, the material for the gate electrode is selected so that the etch rate of the gate electrodes 30 when and etching solution or etching gas is used for the second insulating layer 16 is preferably established to be 1/10 or less of that of the second insulating layer 16. In this embodiment, the gate electrodes 10 can be formed using aluminum Al, chromium Cr, or molybdenum Mo.

The above-structured electron emission device is driven by applying predetermined voltages to the cathode electrodes 28, the gate electrodes 30, the focusing electrode 18, and the anode electrode 24. For instance, a plus (+) scan voltage of several tens to several hundreds volts is applied to the gate electrodes 30, a plus (+) data voltage of several to several tens volts to the cathode electrodes 28, a minus (−) voltage of several tens to several hundreds volts to the focusing electrode 16, and a plus (+) voltage of several hundreds to several thousands volts to the anode electrode 24.

Consequently, an electric field is formed around the electron emission regions 12 in the pixels where the voltage difference between the cathode 28 and the gate electrodes 30 is higher than the threshold value, and electrons are emitted from these electron emission regions 12. The emitted electrons are focused by the focusing voltage while passing the focusing electrode 18, and attracted by the high voltage applied to the anode electrode 24, thus colliding against the phosphor layers 20 in the relevant pixels and emitting visible light as a result.

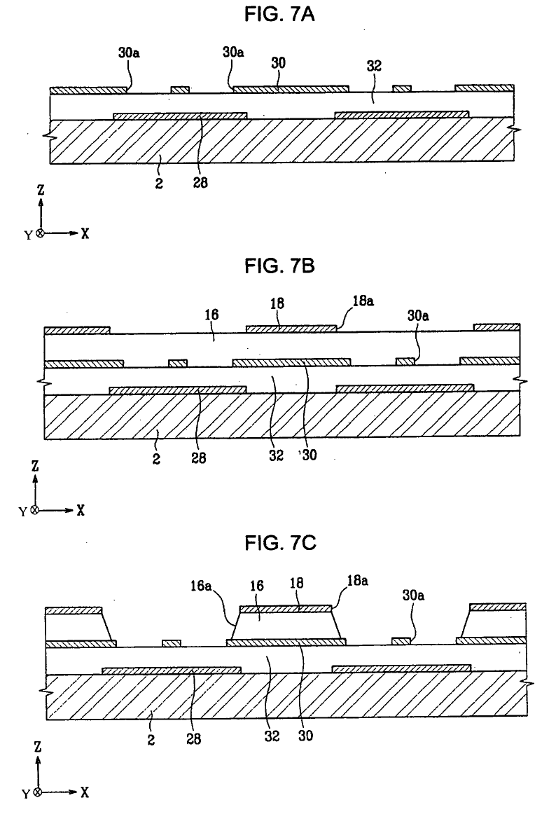

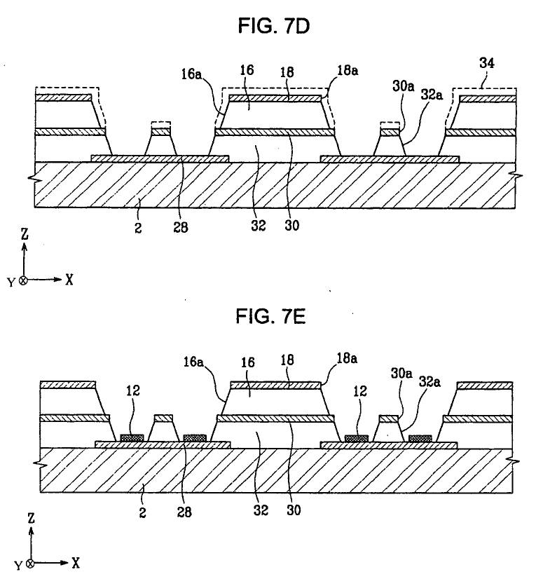

A method of manufacturing the electron emission device illustrated in FIG. 5 according to the present invention will be now explained with reference to FIGS. 7A to 7E. Turning now to FIG. 7A, cathode electrodes 28 are formed with a stripe pattern that extends in a first direction on first substrate 2. A first insulating layer 32 is formed on the entire inner surface of the first substrate 2 covering the patterned cathode electrodes 28. The first insulating layer 32 can be formed to have a thickness of 5-20 μm by performing a screen printing process over and over several times.

A conductive layer is formed on the first insulating layer 32, and patterned to thus form gate electrodes 30 having first opening portions 30a. In consideration of the process of etching and high temperature firing the second insulating layer 16 to be conducted later, the material used for the gate electrode 30 is carefully chosen so that the etch rate of the for the gate electrode 30 is 1/10 of that of the second insulating layer 16. Preferably, the material used in the gate electrode 30 is thermally oxidized to a small degree. Preferred materials for the gate electrode 30 include aluminum Al, chromium Cr, or molybdenum Mo.

After the formation of the gate electrode 30 on the first insulating layer 32, a second insulating layer 16 is formed on the first insulating layer 32 overlaid with the gate electrodes 30 as illustrated in FIG. 7B. The second insulating layer 16 is formed with a material having an etch rate being three times or more of that of the material used in the first insulating layer 32 when an etching solution or an etching gas is used. The second insulating layer 16 is preferably formed to be 10 μm thick by performing the screen printing and high temperature firing over and over several times.

A conductive layer is formed on the second insulating layer 16, and patterned to thus form a focusing electrode 18 perforated by second opening portions 18a. Alternatively, a metallic plate with second opening portions 18a can instead be attached to the second insulating layer 16 to form the focusing electrode 18. As illustrated in FIG. 7C, the second insulating layer 16 is patterned by etching using an etching solution to thus form second opening portions 16a. When the second insulating layer 16 is partially etched to form the opening portions 16a, the damage to the first insulating layer 32 and the gate electrodes 30 can be minimized due to the difference in etch rate of the materials used in the first and the second insulating layers 32 and 16 and the difference in etch rate of the materials used in the gate electrodes 30 and the second insulating layer 16.

Turning now to FIG. 7D, a photoresist pattern 34 is formed over the focusing electrode 18 and exposed portions of the gate electrodes 30 through the second opening portions 16a and 18a. The first insulating layer 32 is etched using photoresist pattern 34 as an etch mask to thus form first opening portions 32a in first insulating layer. Then, the photoresist pattern 34 is detached and removed.

As illustrated in FIG. 7E, an electron emission material is deposited onto the cathode electrodes 28 exposed through the first opening portions 32a to allow for the formation of electron emission regions 12 on cathode electrode 28. In this second embodiment, the formation of the patterned electron emission regions 12 can be achieved using a backside exposure technique where ultraviolet rays illuminate a bottom surface of the first substrate 2. In order to use backside exposure technique to pattern the electron emission regions 12, as illustrated in FIG. 8, opening portions 28a must first formed in the cathode electrodes 28. This allows the electron emission regions 12 to be formed within the opening portions 28a thus filling them. In this backside exposure formation of the electron emission regions 12, the cathode electrode 28 with openings 28a serves as a photolithography mask in the formation of the patterned electron emission regions 12.

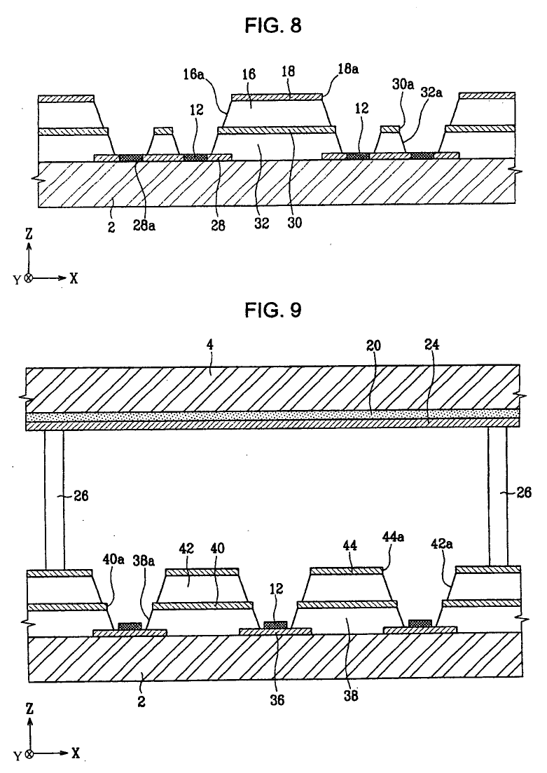

Turning now to FIG. 9, FIG. 9 is a partial sectional view of an electron emission device according to a third embodiment of the present invention. As illustrated in FIG. 9, first opening portions 38a and 40a perforating first insulating layer 38 and gate electrodes 40 respectively are arranged corresponding to opening portions 42a and 44a that perforate second insulating layer 42 and focusing electrode 44 respectively. In this third embodiment, the materials are carefully selected so that the etch rate of the first insulating layer 38 is greater than the etch rate of material used in the second insulating layer 42 when an etching solution or an etching gas is used. Other structural components of the electron emission device according to the third embodiment are the same as those related to the second embodiment.

The etch rate of the of the material that makes up the first insulating layer 38 is established to be at least three times that of the material that makes up the second insulating layer 42. In case the etch rate of the material that makes up the first insulating layer 38 is greater than that of the material that makes up the second insulating layer 42, the second opening portions 42a in the second insulating layer 42 and the first opening portions 38a in the first insulating layer 38 can be formed through only one single etching process.

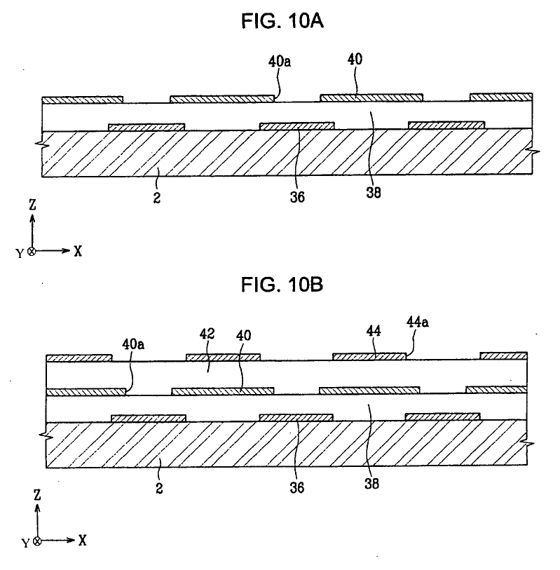

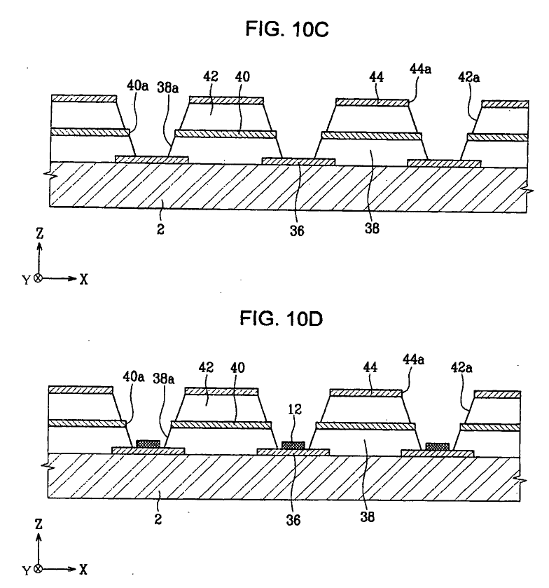

Turning now to FIGS. 10A through 10D, FIGS. 10A through 10D illustrate a method of manufacturing the electron emission device illustrated in FIG. 9 according to the present invention. First, as illustrated in FIGS. 10A, cathode electrodes 36 having a stripe pattern are formed on the first substrate 2 and extend in a first direction. A first insulating layer 38 is formed on the entire inner surface of the first substrate 2 and covering the cathode electrodes 36. The first insulating layer 38 can be formed to have a thickness of 5-20 μm by performing the screen printing several times. A conductive layer is formed on the first insulating layer 38, and patterned to thus form gate electrodes 40 with first opening portions 40a.

Next, as illustrated by FIG. 10B, a second insulating layer 42 is formed on the first insulating layer 38 overlaid with the gate electrodes 40. The second insulating layer 42 is formed using a material having an etch rate being ⅓ or less than that of the material used for the first insulating layer 38. The second insulating layer 42 is preferably formed to have a thickness of at least 10 μm by performing the screen printing and a high temperature firing over and over several times.

A conductive layer is formed on the second insulating layer 42, and patterned to thus form a focusing electrode 44 perforated by a second opening portions 44a. Alternatively, a metallic plate with second opening portions 44a can instead be attached to the second insulating layer 42 to form the focusing electrode 44. The second opening portions 44a of the focusing electrode 44 are arranged to have a one to one correspondence with the first opening portions 40a of the gate electrodes 40. As illustrated in FIG. 10C, the second insulating layer 42 and the first insulating layer 38 are sequentially etched using an etching solution to thus form second opening portions 42a in the second insulating layer 42 and first opening portions 38a in the first insulating layer 38 via a single etching process.

In this third embodiment, as the second opening portions 42a in the second insulating layer 42 and the first opening portions 38a in the first insulating layer 38 are formed using a single etching process, a separate photoresist application and patterning process to pattern the first insulating layer can be omitted, thus eliminating the number of process steps. By having the etch rate of the material used in second insulating layer 42 is small than the etch rate of the material used in the first insulating layer 38, when the first insulating layer is etched, the second opening portions 42a of the second insulating layer 42 are prevented from being enlarged. Therefore, the space for the photoresist patterning is not needed, and this results in enhanced device resolution.

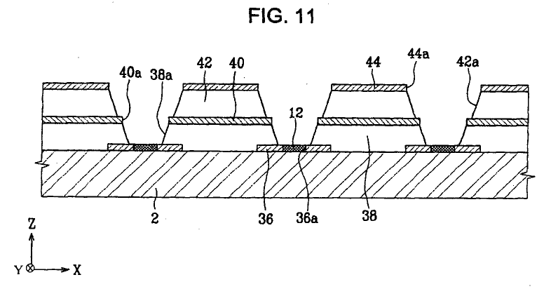

As illustrated in FIG. 10D, an electron emission material is deposited onto the cathode electrodes 36 exposed through the first opening portions 38a and 40a to form electron emission regions 12. In this third embodiment, with the formation of the electron emission regions 12, a backside exposure technique can be used to pattern the electron emission regions 12. This backside exposure technique in forming the patterned electron emission regions 12 in the electron emission device according to the third embodiment is illustrated in FIG. 11. Turning to FIG. 11, opening portions 36a are formed in the cathode electrodes 36, and the electron emission regions are placed within the opening portions 36a thus filling them.

As explained above, the electron emission regions are formed with a material emitting electrons under the application of an electric field, and the driving electrodes being the cathode and the gate electrodes control the emission of electrons from the electron emission regions, but the structure of the electron emission regions and the electron emission electrodes is not limited thereto, and can be altered in various manners and still be within the scope of the present invention.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. A cathode substrate, comprising:
a substrate;
electron emission regions arranged on the substrate;
one or more driving electrodes adapted to control electrons emitted from the electron emission regions arranged on the substrate;
a first insulating layer comprised of a first material and contacting the driving electrodes;
a focusing electrode adapted to focus the electrons emitted from the electron emission regions arranged on the substrate; and
a second insulating layer comprised of a second and different material arranged between the driving electrodes and the focusing electrode.

2. The cathode substrate of claim 1, an etch rate of a first material being different than an etch rate of the second material.

3. The cathode substrate of claim 2, the etch rate of the first material being one-third or less than the etch rate of the second material.

4. The cathode substrate of claim 2, the etch rate of the first material being at least three times the etch rate of the second material.

5. The cathode substrate of claim 1, the driving electrodes comprising a third material, an etch rate of the third material being different than an etch rate of the second material.

6. The cathode substrate of claim 5, the etch rate of the third material is no more than one-tenth the etch rate of the second material.

7. The cathode substrate of claim 1, the electron emission regions comprising a material selected from the group consisting of graphite, diamond, diamond-like carbon, carbon nanotube, C₆₀ and silicon nanowire.

8. An electron emission device, comprising:
first and second substrates facing each other;
first and second electrodes insulated from each other and arranged on the first substrate;
a first insulating layer comprised a first material arranged between the first and the second electrodes;
electron emission regions connected to either the first electrodes or the second electrodes;
a focusing electrode arranged over the first and second electrodes while exposing the electron emission regions;
a second insulating layer comprised of a second material arranged between the focusing electrode and either the first electrodes or the second electrodes, the first material being different than the second material;
phosphor layers arranged on the second substrate; and
at least one anode electrode arranged on a surface of the phosphor layers.

9. The electron emission device of claim 8, an etch rate of the first material being different than an etch rate of the second material.

10. The electron emission device of claim 8, the first electrodes being comprised of a third material and the second electrodes being comprised of a fourth material, the second material and either the third material or the fourth material having different etch rates.

11. The electron emission device of claim 8, the first electrodes, the first insulating layer and the second electrodes being sequentially arranged on the first substrate, the first and the second electrodes each being of a stripe pattern, the first electrodes being orthogonal to the second electrodes.

12. The electron emission device of claim 11, the electron emission regions being arranged at edge portions of the second electrodes, at least one lateral side of each electron emission region being surrounded by the second electrode.

13. The electron emission device of claim 11, further comprising counter electrodes spaced apart from the electron emission regions and between the second electrodes and adapted to receive a same driving voltage as the first electrodes.

14. The electron emission device of claim 13, the second insulating layer and the focusing electrode being arranged to at least partially expose the counter electrodes.

15. The electron emission device of claim 11, an etch rate of the first material being no more than one-third of an etch rate of the second material.

16. The electron emission device of claim 11, the first electrodes being comprised of a third material and the second electrodes being comprised of a fourth material, an etch rate of the fourth material being no more than one-tenth an etch rate of the second material.

17. The electron emission device of claim 14, the counter electrodes being comprised of a fifth material, an etch rate of the fifth material being no more than one-tenth an etch rate of the second material.

18. The electron emission device of claim 11, the first electrodes being perforated with backside exposure opening portions.

19. The electron emission device of claim 8, the second electrodes, the first insulating layer and the first electrodes being sequentially arranged on the first substrate, the first electrodes and the second electrodes each being of a stripe pattern, the first electrodes being orthogonal to the second electrodes.

20. The electron emission device of claim 19, one or more first opening portions being arranged in the second electrodes and in the first insulating layer at respective crossing regions of the first and the second electrodes, the electron emission regions being arranged on the first electrodes exposed through the first opening portions.

21. The electron emission device of claim 20, the second insulating layer and the focusing electrode each being perforated by second opening portions, the second opening portions corresponding to the first opening portions.

22. The electron emission device of claim 19, an etch rate of the first material being no more than one-third an etch rate of the second material.

23. The electron emission device of claim 19, an etch rate of the first material being at least three times an etch rate of the second material.

24. The electron emission device of claim 19, the first electrodes being comprised of a third material and the second electrodes being comprised of a fourth material, the etch rate of the third material being no more than one-tenth an etch rate of the second material.

25. The electron emission device of claim 20, the first electrodes being perforated by backside exposure opening portions that correspond to the first opening portions, and the electron emission regions being arranged within the backside exposure opening portions and filling the backside exposure opening portions.

26. The electron emission device of claim 8, the electron emission regions comprising at least one material selected from the group consisting of graphite, diamond, diamond-like carbon, carbon nanotube, C₆₀ and silicon nanowire.

27. The electron emission device of claim 8, the focusing electrode comprising one of a metallic layer and a metallic plate.

28. A method of manufacturing an electron emission device, comprising:
forming first and second driving electrodes on a first substrate, forming a first insulating layer comprised of a first material between the first substrate and the second driving electrodes and between the first driving electrodes and the second driving electrodes;
forming a second insulating layer comprising a second material on the first and second driving electrodes, the first material having a different etch rate than the second material;
forming a focusing electrode on the second insulating layer; and
partially etching the second insulating layer using an etching solution or an etching gas to partially expose the second driving electrodes.

29. The method of claim 28, further comprising forming electron emission regions on the exposed portions of the second driving electrodes.

30. The method of claim 29, the first material having an etch rate no more than one-third an etch rate of the second material.

31. The method of claim 29, the forming the electron emission regions comprises:
preparing a paste by adding an organic material to at least one material selected from the group consisting of graphite, diamond, diamond-like carbon, carbon nanotube, C₆₀ and silicon nanowire;
screen-printing the paste; and
firing the printed paste.

32. The method of claim 28, further comprising:
partially exposing the first driving electrodes by partially etching the first insulating layer after the partially etching of the second insulating layer; and
forming electron emission regions on exposed portions of the first driving electrodes.

33. The method of claim 32, the first material having an etch rate no more than one-third an etch rate of the second material.

34. The method of claim 32, the first material having an etch rate at least three times an etch rate of a second material.

35. The method of claim 33, the second and the first insulating layers being etched via a single etching process using a same etching solution or a same etching gas.

36. The method of claim 28, the driving electrodes comprise a third material, the third material having an etch rate no more than one-tenth an etch rate of the second material.

37. The method of claim 32, the forming the electron emission regions comprises:
preparing a paste by adding an organic material to at least one material selected from the group consisting of graphite, diamond, diamond-like carbon, carbon nanotube, C₆₀ and silicon nanowire;
screen-printing the paste; and
firing the printed paste.

38. The method of claim 28, the forming the focusing electrode comprises:
forming a conductive layer on the second insulating layer; and
patterning the conductive layer.

39. The method of claim 28, the forming the focusing electrode comprises:
forming opening portions perforating a metallic plate; and
attaching the metallic plate onto the second insulating layer.
